(19) United States
(12) Patent Application Publication
(10) Pub. No.: US 2008/0313254 A1
(43) Pub. Date: Dec. 18, 2008

(54) VIRTUAL FIELDBUS DEVICE

(76) Inventors: Christopher G. Hilemon, Knoxville, TN (US); Kai T. Bouse, Tellico Plains, TN (US)

Correspondence Address: LUEDEKA, NEELY & GRAHAM, P.C., P O BOX 1871, KNOXVILLE, TN, 37901, US

(21) Appl. No.: 11/764,268

(22) Filed: Jun. 18, 2007

(51) Int. Cl. G06F 15/16

(52) U.S. Cl. 709/200

(57) ABSTRACT

A virtual fieldbus device module is a software or firmware module that enables an otherwise ordinary fieldbus device to become a complex fieldbus device, capable of registering and maintaining multiple fieldbus network addresses for one or more “virtual” fieldbus devices. Each virtual fieldbus device has one or more sensor inputs and appears to the fieldbus network as an individual physical fieldbus device, despite the complex fieldbus device only having one physical connection to the fieldbus network. The virtual fieldbus device module may be incorporated into a device's firmware or may be included in a memory plug-in capable of being removed. The communication packet processing of a complex fieldbus device running the virtual fieldbus device module includes receiving a communication packet over the fieldbus network, determining whether the address associated with the packet matches any of the addresses registered by the complex fieldbus device, and processing any packets that match.

### FIELD

This invention relates to data transfer devices and methods. More particularly the invention relates to an apparatus and method for transferring data from a single device on a fieldbus network while appearing to the network as multiple, independent “virtual” devices responding on the network at multiple addresses.

### BACKGROUND AND SUMMARY

In a process environment, such as a factory or industrial plant, various types of machinery are used. Each piece of machinery typically is geographically and strategically distributed throughout the process environment to maximize efficiency of the process. In most processes it is necessary to measure environment and process conditions such as temperature, pressure, flow rates and the like in order to ensure proper process characteristics and to determine whether process machines require preventive or present maintenance. Additionally, in a process control system, control signals, which are often based on measured conditions, are communicated to various field devices.

Typically, a measurement device measures one condition such as temperature or pressure. The measurement device may be physically and logically incorporated into the machine creating a “smart” device. The smart device participates in a control protocol network such as a HART or FOUNDATION™ fieldbus network in order to communicate machine condition data to the control protocol network. The control protocol network is part of a process control system or makes up the process control system. In preferred embodiments, machine fault determination is performed at the device and the results, possibly including the raw measurement data, are communicated to a central processor. The central processor uses the information an advisory fashion to make scheduling and/or operational decisions, possibly including preventive or remedial maintenance. If several different conditions must be measured on the same or different machines, typically several measurement devices are used. The several measurement devices communicate with the control protocol network individually by each occupying a narrowly mapped network address.

The use of individual physical measurement devices for measuring various conditions requires connection wires from each measurement device to an individual network link. Some devices communicate data relating to multiple machines to the control protocol network using only one address. Communicating the health of multiple machines over one address causes several problems including sorting the data so that it accurately corresponds to the proper machine or device. Furthermore, if a measurement device reads a condition and communicates data representing the condition to the control protocol network, the data must be communicated to the central station for analysis. If it is determined that the measured condition requires further action, control signals must be transmitted across the control protocol network to the proper controlled device, causing potentially costly delays in preventive maintenance and/or shutdown commands.

Previous field devices attempted to report the health of multiple distinct machines such as pumps, motors, turbines or the like as a single fieldbus device. That is, a field device took up only one “slot” on the fieldbus network but transmitted data corresponding to several distinct measurements either on only one machine or several machines. In some situations, such field devices led to ambiguity regarding the source of an alarm and the overall health of the multiple machines.

As discussed in U.S. Pat. Appl. Publ. No. 2006/0101111 to Bouse et al., which is fully incorporated herein by reference, a fieldbus network bandwidth generally is allocated using a time-division multiplexing method of “slots” and a “token ring.” Accordingly, time available for transferring arbitrary “unscheduled” data within the overall macro-cycle was limited.

Thus, there is a need for a fieldbus device capable of accepting signals representing measurements from multiple measurement instruments and for communicating data corresponding to the signals over a control protocol network by appearing to the control protocol network as multiple, independent “virtual” devices responding on the control protocol network at multiple addresses.

There is also a need for a machine-side hub for accepting signals from multiple machine devices, including measurement instruments, analyzing the signals, and communicating control signals to other machine devices connected to the hub, without the necessity of communicating across the control protocol network, that is, such that communication between or among fieldbus devices need not be communicated over the fieldbus network.

The above and other needs are met by a virtual fieldbus device module, which is a software or firmware module for running on a physical fieldbus device, such as a complex fieldbus device, making the fieldbus device capable of registering and maintaining multiple fieldbus network addresses for virtual fieldbus devices associated with the complex fieldbus device. The virtual fieldbus device reduces costs associated with wiring and simplifies the interface to the control system by appearing as multiple simple devices at distinct network addresses, rather than a single complex device with a single network address representing a multiplicity of values, with the associated ambiguity of matching the value with the correct monitored machine. The virtual fieldbus device is configurable in the field to accept varying numbers and types of inputs and represent a number of such inputs on the fieldbus network as one or more virtual fieldbus devices.

### BRIEF DESCRIPTION OF THE DRAWINGS

Further advantages of the invention are apparent by reference to the detailed description when considered in conjunction with the figures, which are not to scale so as to show more clearly the details, wherein like reference numbers indicate like elements throughout the several views, and wherein:

FIG. 1A is a diagram of a fieldbus network having a standard configuration.

FIG. 1B is a flowchart representing the communication packet processing performed by an ordinary fieldbus device functioning in a fieldbus network having a standard configuration and the communication packet processing performed by a super device functioning in a fieldbus network.

FIG. 1C is a diagram of a fieldbus device.

FIG. 2A is a diagram of a fieldbus network having a proxy device configuration using a point-to-point connection arrangement.

FIG. 2B is a diagram of a fieldbus network having a proxy device configuration using a multi-drop connection arrangement.

FIG. 2C is a flowchart representing the communication packet processing performed by a proxy device functioning in a fieldbus network having a proxy device configuration.

FIG. 3 is a diagram of a fieldbus network having a super device configuration.

FIG. 4A is a diagram of a fieldbus network having a complex fieldbus device.

FIG. 4B is a flowchart representing the communication packet processing performed by a complex fieldbus device having a virtual fieldbus device module.

### DETAILED DESCRIPTION

A virtual fieldbus device module provides flexible network addressing for a complex analytical physical field device. Specifically, “sub-devices,” for example a motor monitor, a gear monitor, a pump monitor or the like, have multiple sensors connected to the physical field device. The virtual fieldbus device module makes the physical field device appear to the fieldbus network as one controlling supervisory device, with its sub-devices each appearing to the fieldbus network as separate additional monitoring and control devices regardless of the number of sensors supplying each sub-device.

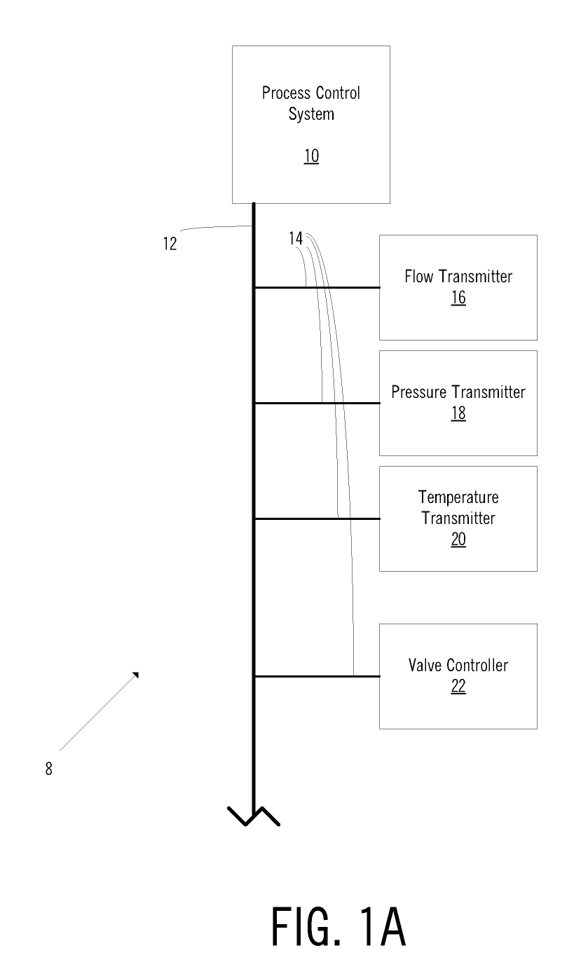

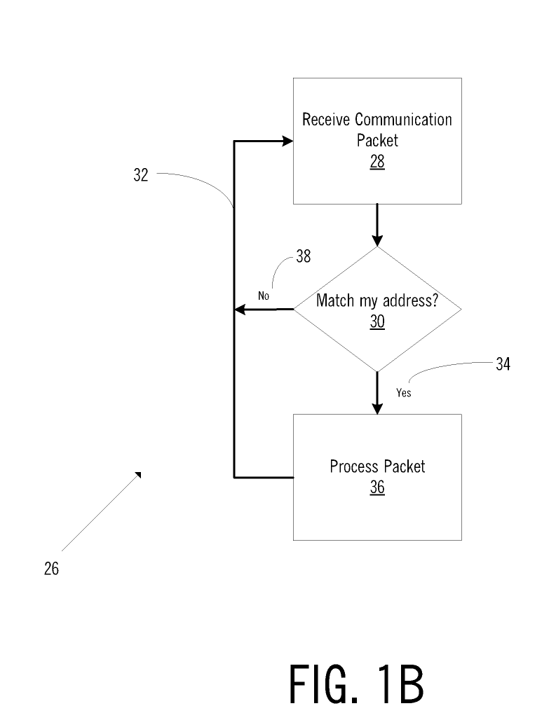

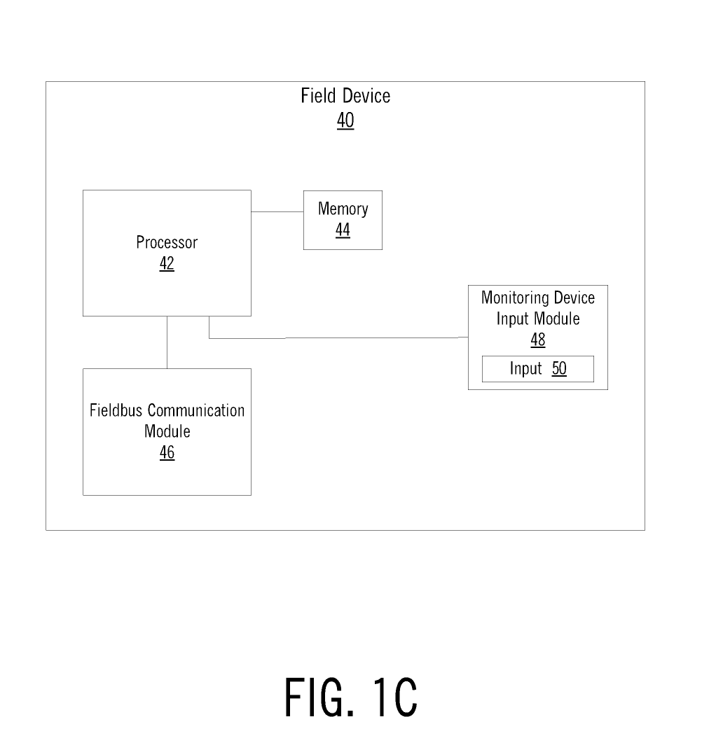

Referring now to FIG. 1A, a standard fieldbus configuration 8 is shown. A process control system 10 is connected to a fieldbus field network 12 distributed through a process environment. The process control system 10, in some embodiments, includes a process controller connected to a backbone network such as an in-plant Ethernet network connected with at least one host computer or central station or server. The fieldbus field network 12 has a plurality of physical connections 14 to field devices, such as a flow transmitter 16, a pressure transmitter 18, a temperature transmitter 20, and a valve controller 22. A configuration such as this, wherein each field device is individually connected physically to the fieldbus field network 12 is referred to as a multi-drop configuration. In this configuration, each field device requires an individual distinctive network address and individual wiring to each device. The fieldbus network 12, in simple terms, functions by assigning a network address to each individual field device, and each individual field device communicates on the fieldbus network at the assigned address.

Communication between different field devices, such as the pressure transmitter 18 and the valve controller 22, requires transmission across the physical connection 14 and through the fieldbus field network 12. Such transmission may delay important control signal transmission or other important communications. For example, when the pressure transmitter 18 detects a pressure above a predetermined pressure threshold in a conduit of a process system, it constructs a communication packet indicating the pressure level and having an intended recipient specified by a network address. In this example, the pressure transmitter 18 is programmed to send critical pressure information over the fieldbus network with a label specifying the network address of the valve controller 22. Once the communication packet is uploaded by the pressure transmitter 18, the communication packet is communicated across the fieldbus field network until it is received by the valve controller 22, which performs a communication stack process on the communication packet.

Referring to FIG. 1B, a communication stack process 26 of a standard fieldbus configuration 8 (FIG. 1A) is shown. First, the communication packet, such as the communication packet uploaded by the pressure transmitter 18 in the example above, is received by the field device as represented by block 28. Next, the field device determines whether the communication packet is identified as intended for the network address corresponding with this particular field device as represented by decision block 30. If the field device determines the received communication packet is not intended for the network address corresponding to this field device (as represented by arrow 38), the communication stack process 24 continues to monitor the fieldbus field network 12 for communication packets as represented by arrow 32. If the field device determines the communication packet is intended for the network address corresponding to this field device (as represented by arrow 34), the field device processes the communication packet as represented by block 36. Once the communication packet is processed 36, the field device continues to monitor the fieldbus field network for communication packets as represented by arrow 32.

Referring to FIG. 1C, a block diagram of one embodiment of a fieldbus field device, also referred to as a field device 40, is shown. Typically, a field device 40 has a processor 42 connected to a memory 44, which stores various software and firmware algorithms including the field device's fieldbus network communication protocol and communication stack processing instructions. The processor 42 is also connected to a fieldbus communication module 46, which receives and sends communications on the fieldbus field network 12 (FIG. 1A). A monitoring device input module 48 is connected to the processor 42 and a monitoring device input 50. In some embodiments, the monitoring device input module has multiple inputs 50. The monitoring device input 50 receives a monitoring signal from a monitoring device such as a flow sensor, a pressure sensor, a temperature sensor or the like. In the example discussed above with reference to FIG. 1B, the pressure transmitter 18 is a field device 40 such as the one shown in FIG. 1C. The pressure transmitter 18 (FIG. 1A) receives, at the input 50 of its monitoring device input module 48, a pressure signal from a pressure sensor disposed on a conduit. The processor 42 determines that the pressure reading requires transmission over the fieldbus field network 12 (FIG. 1A) based on the pressure transmitter's pre-programmed instructions stored in its memory 44. A communication packet is constructed and the fieldbus communication module 46, which is interfaced to the fieldbus field network 12 (FIG. 1A), communicates the communication packet indicating the pressure level and the intended recipient field device network address over the fieldbus network 12 (FIG. 1A).

Next, the valve controller 22 (FIG. 1A) performs the communication stack process 26 shown in FIG. 1B and controls a valve based on its pre-programmed instructions and the received communication packet.

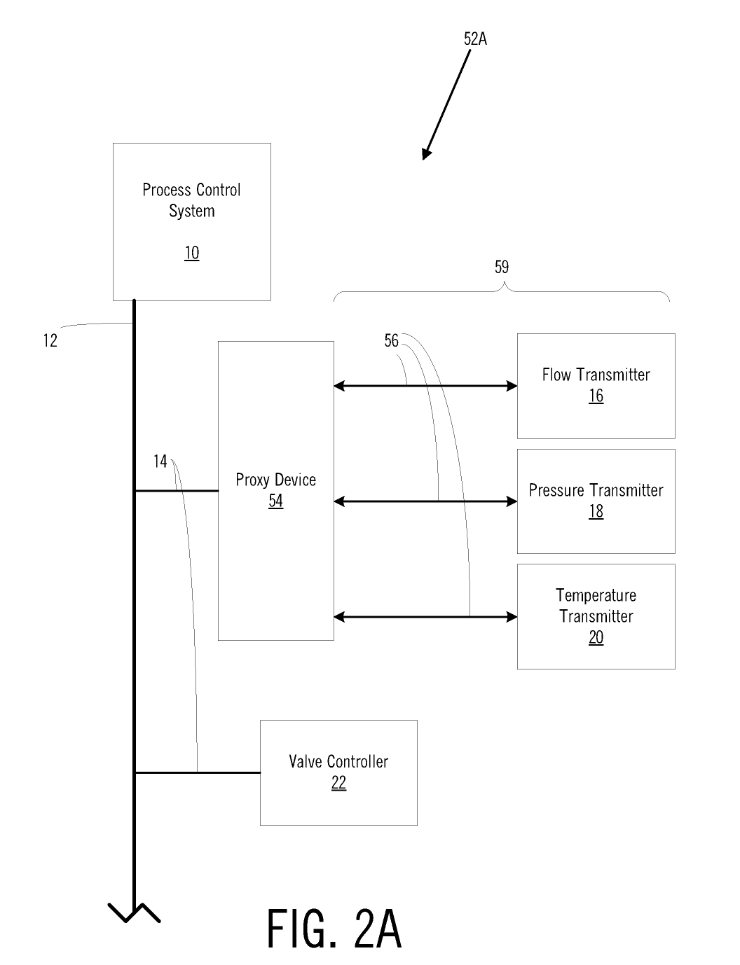

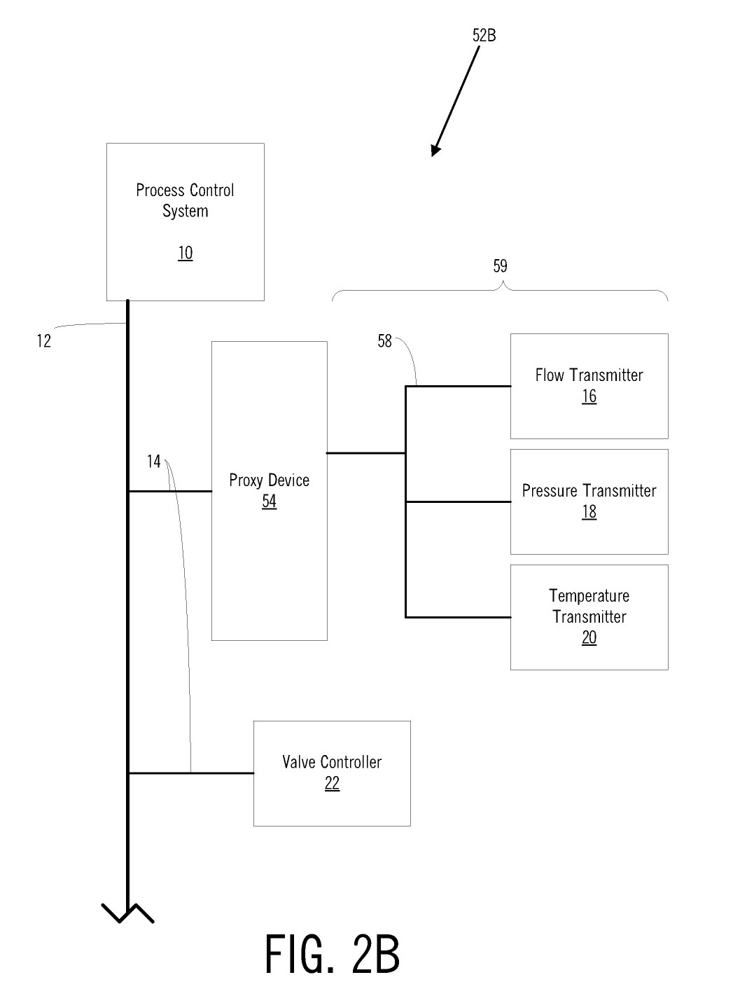

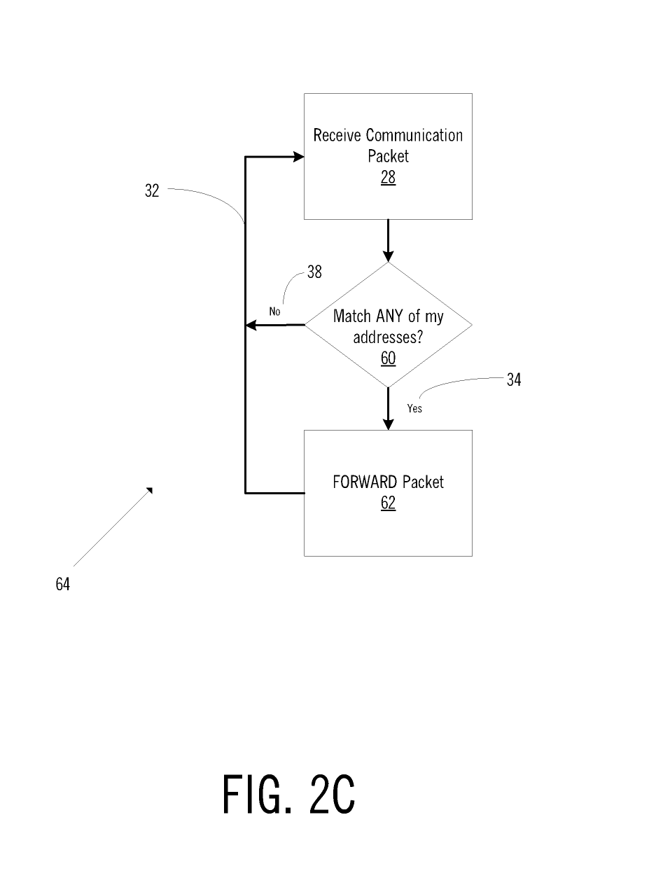

Referring now to FIG. 2A, a proxy or gateway device fieldbus configuration 52A (referred to herein as “proxy fieldbus configuration”) with a multi-dropped connection arrangement 56 is shown. FIG. 2B shows a proxy fieldbus configuration with a point-to-point or star 58 connection arrangement. FIGS. 2A and 2B are discussed collectively herein, as the only difference between the two configurations is their respective connection arrangements. In these embodiments, a single physical field device or proxy device 54 is multi-dropped over physical connection 14 with fieldbus network 12 and acts as a concentrator, gateway, or protocol converter for multiple individual field devices, such as flow transmitter 16, pressure transmitter 18, and temperature transmitter 20. A proxy address table stores the fieldbus addresses of each remote field device 16, 18 and 20 as each individual device comes online on the extended or remote network.

The field devices 16, 18 and 20 are considered remote from the fieldbus network and are sometimes referred to as “daisy-chained” devices in these embodiments because they are not directly connected, such as in a multi-drop configuration, with the fieldbus network 12. The connections 56 or 58 and remote field devices 16, 18 and 20 separated from the fieldbus network 12 by the proxy device 54 are referred to as an extended network 59. The remote field devices 16, 18 and 20 may use one or more fieldbus protocols, and the proxy device 54 communicates with the various remote field devices 16, 18 and 20 and stores all of the network addresses for each separate remote field device 16, 18 and 20. The storing of network addresses in the proxy device 54 is also referred to herein as “registering” the addresses.

Referring to FIG. 2C, the communication stack processing 64 of the proxy device 54 is shown. When proxy device 54 receives a communication packet over the fieldbus network 12 (as represented by block 28), the proxy device 54 compares the address associated with communication packet against the network addresses stored in its proxy address table (as represented by decision block 60). If the address corresponds to any of the addresses in the proxy address table, the proxy device 54 forwards the communication packet to the field device having the matching address (as represented by block 62). Once the communication packet is forwarded over the extended network 59, the proxy device 54 continues to monitor the fieldbus network 12 for communication packets (as represented by arrow 32). Referring back to decision block 60, if the address of the received communication packet does not match any of the addresses stored in the proxy address table, the proxy device 54 continues to monitor the fieldbus field network 12 for communication packets (as represented by arrow 32) without forwarding the communication packet over the extended network 59.

In the embodiments of FIGS. 2A, 2B and 2C, communication between individual field devices 16, 18 and 20 requires transmission across physical wires, for example 56, 58 or 14. However, in the configuration of FIG. 2B, the communication may be confined to the extended network 59 in a multi-drop configuration and not flow through the proxy device 54. In the point-to-point configuration 56 shown in FIG. 2A, communication between field devices, for example, flow transmitter 16 and pressure transmitter 18, requires communication through the proxy device 54.

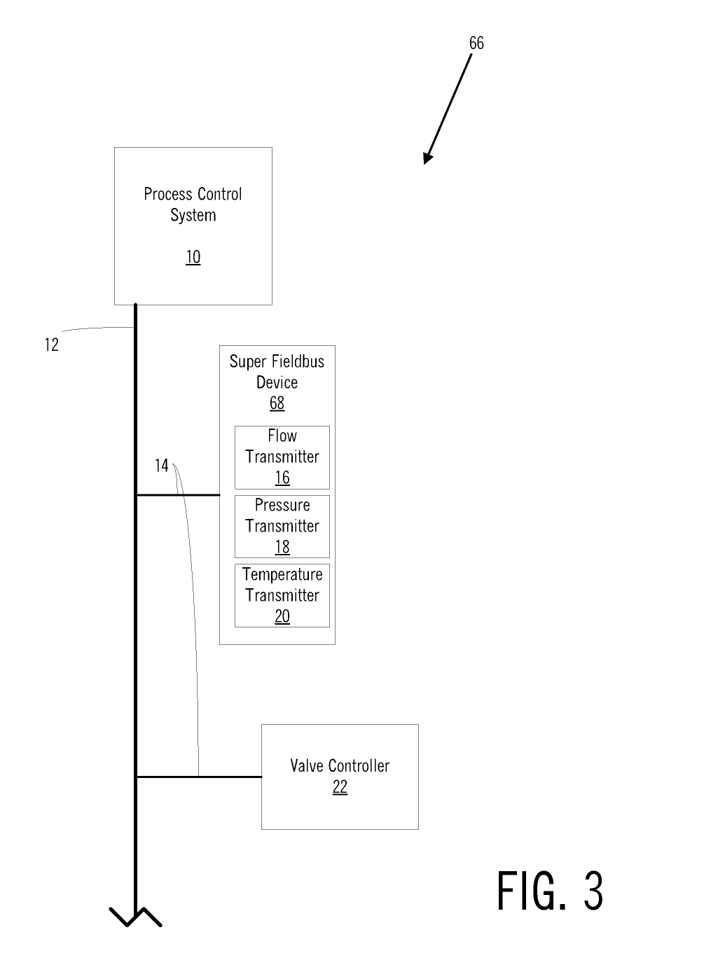

Referring now to FIG. 3, a super fieldbus device configuration 66 is shown. In this configuration the super device 68 is a single physical field device multi-dropped off a fieldbus network 12 over connection 14. The super device 68 is identified by a single fieldbus network address and does not store separate addresses for any sub-devices such as 16, 18 and 20. Thus, each field device 16, 18 and 20 is not identified by and does not require a separate and individual fieldbus address.

In this embodiment, communication stack processing is performed as shown in FIG. 1B. Referring back to FIG. 1B, when the super device 68 receives a communication packet as represented by block 28, it determines whether the fieldbus address associated with the communication packet matches the super device's address as represented by decision block 30. If the communication packet does match the super device's fieldbus address, the super device 68 processes the communication packet as represented by block 36. If not, the super device 68 continues to monitor the fieldbus network for communication packets as represented by arrow 32.

Referring back to FIG. 3, communication between sub-devices such as flow transmitter 16 and pressure transmitter 18 does not require transmission across a physical network connection such as 14 or the fieldbus network 12.

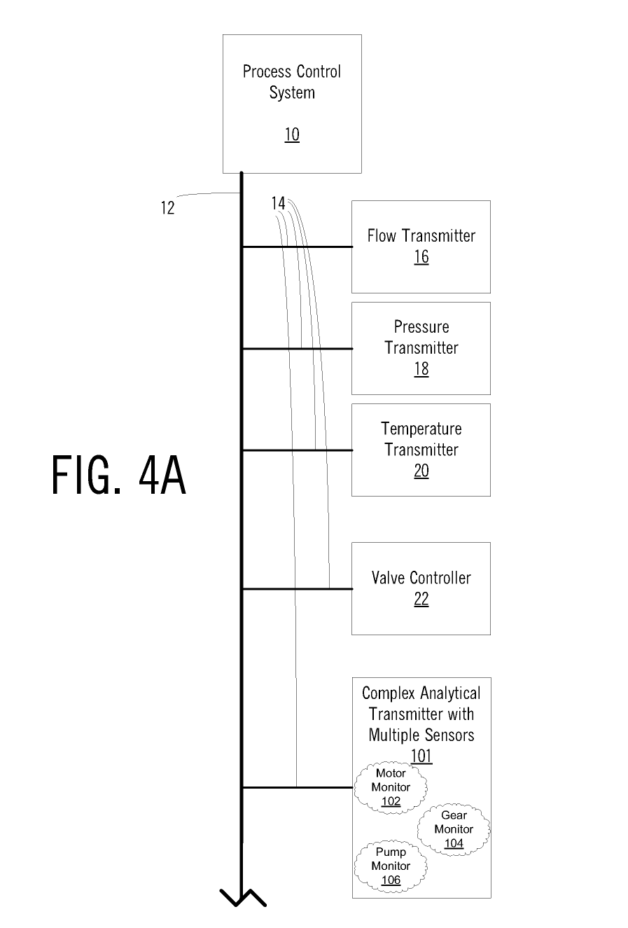

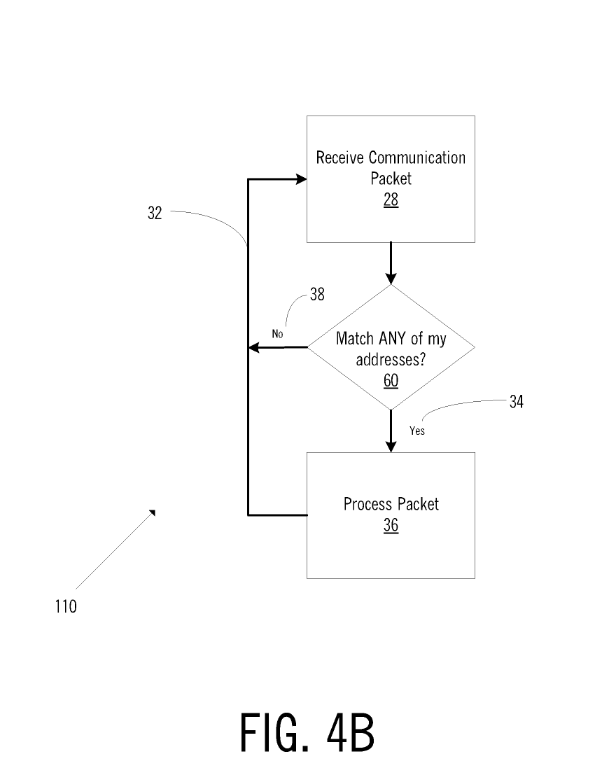

Referring now to FIG. 4A, a virtual fieldbus device configuration 100 including a complex analytical field device 101 (referred to herein as a complex field device) is shown. The complex field device 101 is multi-dropped off the fieldbus network 12. Similar to the proxy device 54 discussed above with reference to FIG. 2, the complex field device 101 has one or more fieldbus addresses, one of which is a first address for the complex field device 101 itself. In addition to the first address, the complex field device 101 stores addresses used by sub-devices such as the motor monitor 102, gear monitor 104 and pump monitor 106 shown in FIG. 4A. Adaptation to various applications is simplified by grouping sensors into sub-devices. Each of the sub-devices is assigned a separate fieldbus address as if it were an independent standard field device. However, the complex field device 101 only has one physical connection 14 to the fieldbus network 12 thereby reducing the costs associated with wiring multiple devices.

Each sub-device 102, 104 and 106 is referred to herein as a virtual device because it is a subset of the sensing and/or computing resources of the overall physical complex field device 101. For example, in one embodiment, the complex field device 101 provides eight (8) physical inputs for sensors. The motor monitor virtual sub-device 102 uses four (4) of the sensor inputs, the pump monitor virtual sub-device 104 uses two (2) of the sensor inputs, and the gear monitor virtual sub-device 106 uses two (2) sensor inputs. Thus, the eight (8) sensor inputs are distributed among the virtual sub-devices. The complex field device 101 requires its own fieldbus network address. In addition, each of the motor monitor 102, the gear monitor 104, and the pump monitor 106 take-up one (1) fieldbus network address each. Thus, a total of four (4) fieldbus network addresses are used by the complex field device 101 and its virtual sub-devices 102, 104 and 106.

In another example of this embodiment, the motor monitor 102 uses five (5) sensor inputs, the pump monitor 106 uses three (3) sensor inputs, and the gear monitor 104 is not enabled and therefore does not use any sensor inputs. In some embodiments, multiple virtual sub-devices monitor physical devices that are coupled or interacting with one another. In one embodiment, the motor and pump are coupled in the process system. In this case, the complex field device 101 uses one (1) fieldbus network address, the motor monitor 102 and the pump monitor 106 each use one (1) fieldbus network address for a total of three (3).

Referring to FIG. 4B, the communication stack processing 110 for the complex field device 101 is shown. When the complex field device receives a communication packet as represented by block 28, it determines whether the address associated with the communication packet corresponds to the address used by the complex field device 101 or any of the fieldbus network addresses associated with any of its virtual sub-devices as represented by decision block 60. If the address associated with the communication packet matches any of the addresses associated with the complex field device 101 (as represented by arrow 34), the complex field device 101 processes the communication packet as represented by block 36. If the address associated with the communication packet does not match any of the addresses associated with the complex field device 101 (as represented by arrow 30), the complex field device 101 continues to monitor the fieldbus network for communication packets as represented by arrow 32.

In the embodiment of FIG. 4B, communication between and among virtual sub-devices is contained within the complex field device 101 and does not require transmission across any physical wires outside the complex field device 101.

In a preferred embodiment, the complex field device 101 is controlled by a firmware module stored in its memory 44 (FIG. 1C) or otherwise accessible by the complex field device 101. The firmware module, which is referred to herein as a virtual fieldbus device module, allows any fieldbus device to appear as multiple fieldbus devices on the fieldbus network. The above-described communication packet processing and fieldbus protocol interaction between the complex fieldbus device 101 and the fieldbus network is governed by the virtual fieldbus device module. Using the virtual fieldbus device module, an otherwise ordinary fieldbus device, such as a complex fieldbus device 101 as shown in FIG. 4A, may function as a “smart” device, without requiring additional physically integrated electronics. Additionally, as discussed above, the virtual fieldbus device module allows the complex fieldbus device 101 to function as a proxy for one or more field devices in an extended network 59. In this situation, each device, a portion of each device, or a combination of devices appears to the fieldbus network as an independent smart device having its own fieldbus network address. Thus, the complex field device 101 executing a virtual fieldbus device module is configurable to present itself as any number and type of “virtual” fieldbus devices, such as the motor monitor 102, gear monitor 104 and pump monitor 106 of FIG. 4A.

The virtual fieldbus device module may be stored in memory of an otherwise ordinary fieldbus device, thus creating a complex fieldbus device capable of registering multiple fieldbus addresses on the fieldbus network and managing a variety of “virtual” fieldbus devices or sub-devices as discussed above. Alternatively, the virtual fieldbus device module may be incorporated into the firmware of a complex fieldbus device, such that the complex fieldbus device is capable of registering and maintaining multiple fieldbus network addresses and processing any communication packet received from the fieldbus network matching any of the registered fieldbus addresses without needing to forward the communication packet to another fieldbus device.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for transferring data in a fieldbus network including a fieldbus device having a memory and a processor and at least one additional sub-device, where the fieldbus device has only a single physical network connection, the method comprising:
(a) registering a first fieldbus network address for the fieldbus device;
(b) registering at least one additional fieldbus network address for the at least one additional sub-device such that the at least one additional sub-device appears to the fieldbus network as a second physical device although it is actually a sub-component of the fieldbus device and is collocated at the single physical network connection;
(c) receiving a communication packet having an associated fieldbus network address from the fieldbus network;
(d) determining whether the associated fieldbus network address of the communication packet contains information indicating a match with the first fieldbus network address;
(e) processing the communication packet if the associated fieldbus network address of the communication packet contains information indicating a match with the first fieldbus network address;
(e) determining whether the associated fieldbus network address of the communication packet contains information indicating a match with the at least one additional fieldbus network address; and
(f) processing the communication packet if the associated fieldbus network address of the communication packet contains information indicating a match with the at least one additional fieldbus network address.

2. The method of claim 1 wherein the fieldbus device has a second additional sub-device and the method further comprises the step of communicating between the first sub-device and the second sub-device independently of communications over the fieldbus network.

3. The method of claim 1 wherein one or more of the steps are performed based on instructions provided by a fieldbus device firmware module stored in the memory of the fieldbus device.

4. The method of claim 1 wherein one or more of the steps are performed based on instructions provided by a fieldbus device software module stored in a removable memory device, and the method further comprises removably connecting the removable memory device with the fieldbus device such that the processor of the fieldbus device performs the instructions of the fieldbus device software module stored in the removable memory device.

5. A complex fieldbus device for transferring a plurality of communication packets each having a corresponding associated fieldbus network address over a fieldbus network, the complex fieldbus device for connecting with one or more additional physical fieldbus devices, the complex fieldbus device comprising:
a memory for storing a complex fieldbus device network address associated with the complex fieldbus device and one or more additional fieldbus network addresses associated with the one or more additional physical fieldbus devices;
a fieldbus communication module for sending and receiving the plurality of communication packets over the fieldbus network
a processor for determining whether the network address of a received communication packet contains information indicating a match with any of the one or more additional physical fieldbus network addresses; and
an input/output module connected to the processor and having at least one port for communicating an input/output signal with the one or more additional physical fieldbus devices when the associated network address of the received communication packet contains information indicating a match with one or more of the additional physical fieldbus network addresses.

6. The complex fieldbus device of claim 5 wherein the complex fieldbus device is further for connecting with one or more further additional physical fieldbus devices and wherein a registered additional fieldbus network address is associated with a virtual fieldbus device representing one or more sub-devices.
